(19) United States
(12) Patent Application Publication
(10) Pub. No.: US 2003/0167664 A1
(43) Pub. Date: Sep. 11, 2003

(54) Overlay calendar

(76) Inventor: Bruce Mullinax, Falls Church, VA (US)

Correspondence Address: McGuire Woods LLP, 1750 Tysons Boulevard, Suite 1800, Tysons Corner, McLean, VA, 22102-4215, US

(21) Appl. No.: 10/379,901

(22) Filed: Mar. 6, 2003

Related U.S. Application Data
(60) Provisional application No. 60/363,185, filed on Mar. 11, 2002.

(51) Int. Cl. G09D 3/00

(52) U.S. Cl. 40/107; 40/119

(57) ABSTRACT

A calendar having two or more months represented on the same graphic. In this representation, each month represented on a single graphic would begin on a same day, for instance January and October 2003 begin on Wednesday. The months may end on the same or different day. The calendar can be utilized to have months of the same year or different years, as well. The overlay calendar may also be combination overlay-memo calendar. In this embodiment, the overlay calendar has room for the user to write permanent or erasable memos on each of the areas that represent a day of the month. The calendar may be color coded or have other types of indicia and may be provided with indicia showing the end day for each month on the calendar.

### CROSS REFERENCE TO RELATED APPLICATIONS

This application claims priority to U.S. Provisional Application Serial No.: 60/363,185 filed on Mar. 11, 2002, the entire contents of which are herein incorporated by reference.

### DESCRIPTION

### BACKGROUND OF THE INVENTION

1. Field of the Invention

The present invention generally relates to an overlay calendar and, more particularly, to a calendar that combines certain months together onto one shared graphic representation.

2. Description of the Prior Art

FIG. 1 shows a graphic representation (graphic) of a month, January 2003 of the Gregorian calendar in this example. In a normal calendar only one month is represented by each graphic. In a Gregorian, Julian, Jewish, or Islamic calendar, months and days and dates are graphically represented for each year. In one known example, each month is represented separately from each different month. Within each monthly segment, indicia/symbols are used to represent the days in that month. This usually results in a calendar having at least a page for each month.

### SUMMARY OF THE INVENTION

It is therefore an object of the present invention to provide a calendar with fewer parts and a longer life than a regular calendar of similar size.

In a first aspect of the invention, an overlay calendar is provided with at least one single graphical representation for at least two months. The single graphical representation includes a name of each of the at least two months, indicia representing each day of a week associated with any month of a year, and date indicia associated with each of the dates for each of the at least two months. The overlay calendar also includes an end day indicia signifying end days for the each of the at least two months. Each of the at least two months on the single graphical representation begin on a same day.

In embodiments, the at least two months is three or more months. The overlay calendar may also include additional space for a user to write permanent or erasable memos on each of the areas that represent a day of the month. The at least two months are in a same year or are in different years. The order of the different months is not required to be in sequential order from one graphical representation to another graphical representation. Indicia associated with each month's names for pointing to a next graphical representation that shows a displayed next upcoming month for a same year or a different year may be provided. The single graphical representation is formed on a single page or on different pages, or on different sides of the page. Numbers or symbols may be placed next to a name of each of the at least two months to show how many days are in each month. The graphical representations may include tabs.

In another aspect of the invention, an overlay calendar comprising at least one single graphical representation for at least two months is provided. The single graphical representation includes at least two months, indicia representing each day of a week associated with any month of a year, and date indicia associated with each of the dates for each of the at least two months and an end day indicia signifying end days for the each of the at least two months. Each of the at least two months on the single graphical representation begin on a same day. In embodiments, names of the at least two months are located on the single graphical representation or on a nearby location signifying the at least two months on the single graphical representation.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a graphic representation of a conventional calendar showing the month of January 2003 of the Gregorian calendar;

FIG. 2 shows a calendar of the present invention having two months represented on the same graphic;

FIG. 3 shows a calendar of the present invention with two months represented on the same graphic; and

FIG. 4 shows a calendar of the present invention with months from different years on the same graphic.

### DETAILED DESCRIPTION OF A PREFERRED EMBODIMENT OF THE INVENTION

The present invention is directed to an overlay calendar. The present invention provides a calendar with fewer parts and a longer life than a regular calendar of similar size.

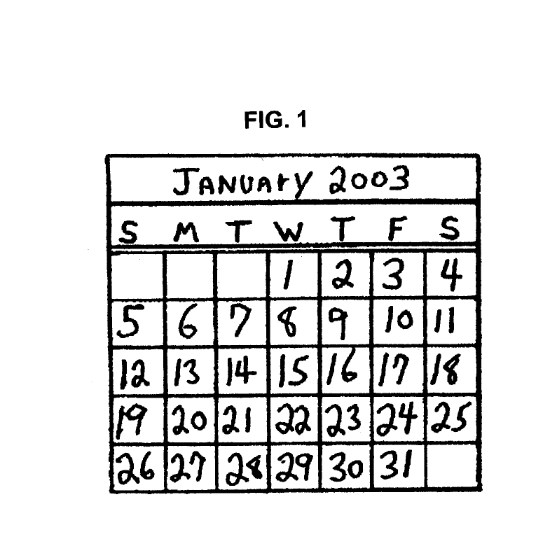

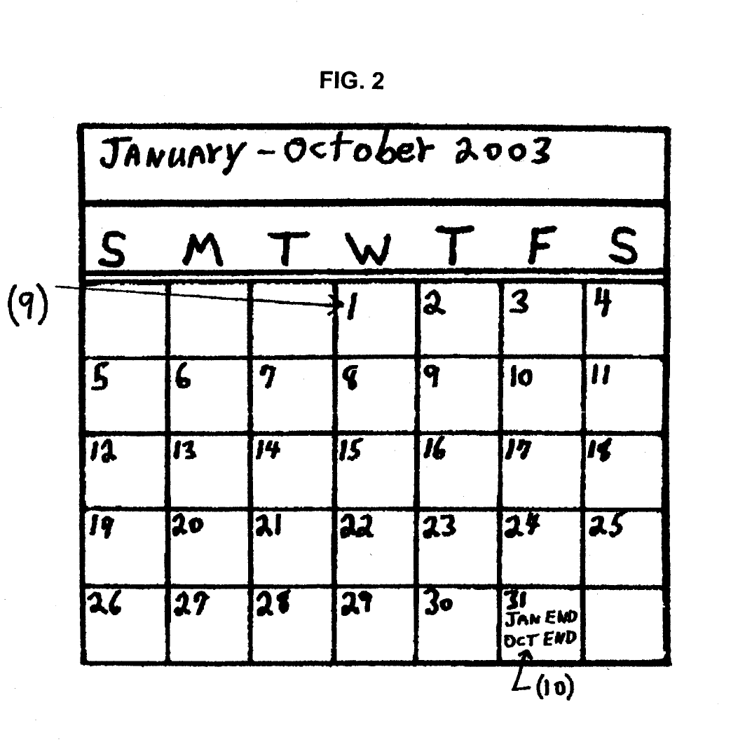

FIG. 2 shows a calendar of the present invention having two months represented on the same graphic. In this representation, both January and October 2003 begin on a day with the same name, Wednesday, as represented by reference numeral 9. In this representation, the two months also end on a day with the same name, Friday, as represented by reference numeral 10. It is contemplated that some indicia is placed in or near the end days 10 to inform the user which end day belongs to the respective month. In the representation of FIG. 1, the words “January End” and “October End” inform the user of the end date for each month. Other names, indicia or otherwise are also contemplated by the present invention. However, one of the overlying concept of the present invention is the ability to combine at least two months having the same beginning day name on the same graphical representation.

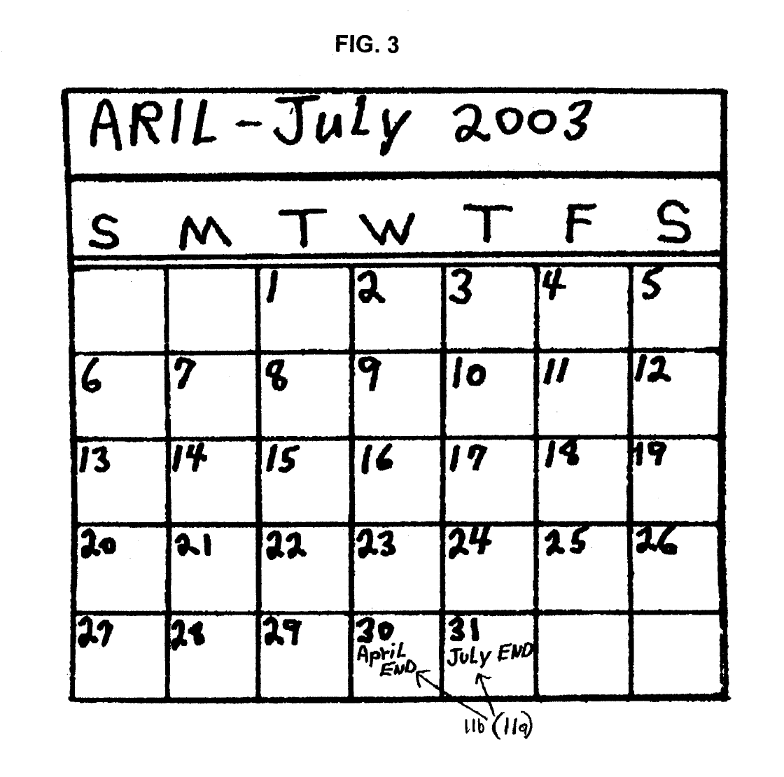

FIG. 3 shows a calendar of the present invention with two months represented on the same graphic. In this representation, the months of April and July of 2003 begin on a day with the same name, Tuesday. In this case, the two months end on days with different names as depicted by reference numerals 11a and 11b. As in FIG. 2, indicia are placed in or near the end days allowing the user to know the end days for each month.

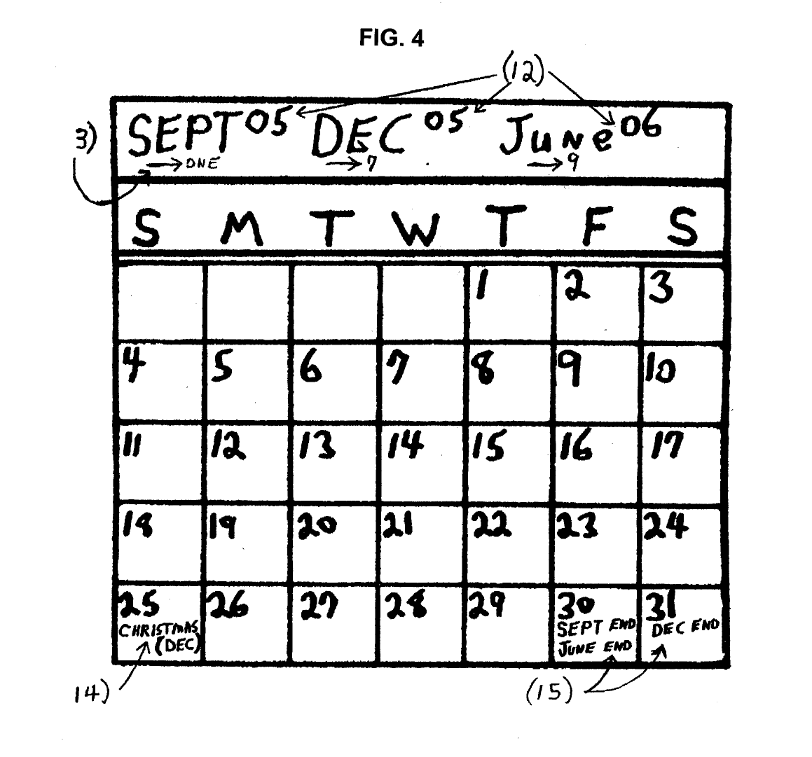

FIG. 4 shows a calendar of the present invention with months from different years on the same graphic. In this representation, the numbers 06 and 05 are representative of the year of each month as depicted by reference numeral 12. Indicia 3 directly under the month's names 13 point to the page/graphic number that shows the next upcoming month to be displayed (arrows pointing at numbers in this case). Information relevant to a given month is displayed on or near the day indicia 14. The months represented on this graphic end on days with different names as depicted by reference numeral 15. The overlay calendar of the present invention may also be combination overlay-memo calendar. In this embodiment, the overlay calendar has room for the user to write permanent or erasable memos on each of the areas that represent a day of the month, as seen in FIG. 4 (Christmas).

Within the concepts of the present invention, months that begin on a day with the same name are termed “compatible months”. In the overlay calendar of the present invention, these compatible months would be combined onto a single graphic representation (“graphic”) such as shown in FIG. 2. In such a situation, indicia/symbols would be placed on or near the common last day of the months that shared a graphic. The indicia/symbols would show that these months end on the same numbered day such as the 31^{st} day of the month for FIG. 2.

Some compatible months that begin on a day with the same name are not an equal number of days long. In such a situation, their shared graphic would show a number of days equal to the longest month(s) sharing the graphic such as shown in FIG. 3. Indicia/symbols would then be placed near or on appropriate days to show each month's ending day within the shared graphic (11a, 11b), drawing #3. If a graphic shared more than two months, all the months could end on the same-name day, all the months could end on different named-days, or some months could end on the same-named day and others not. There is no requirement that all compatible months share the same graphic.

Months that share their graphic representation are provided in the overlay calendar. A feature of the overlay calendar is combining months that begin on a day with the same name onto a single graphic. The overlay calendar thus results in a calendar with fewer graphics, with an equal or longer life than a regular calendar of similar size. Fewer graphics gives numerous advantages such as lower consumer cost, lower production cost, reduced consumption of material, reduced pollution (especially with paper calendars), lower transportation cost, and less waste material. With an equal or longer life and comparatively fewer graphics, the overlay calendar of the present invention would have a clear market advantage over a regular calendar of similar size.

This sharing of a graphic is not limited to months within a single year. Months from different years can share a graphic. This is represented as an one example in FIG. 4. A multi-year overlay calendar could also be made by attaching two or more one-year overlay calendars of the present invention together.

### Elements of The Present Invention

1. Months that begin on a day with the same name (compatible months) are grouped together onto a single graphic. There is no requirement that all compatible months share the same graphic

2. Indicia/symbols would clearly mark the ending day of each month sharing a graphic.

3. Information placed on the days of the month and other parts of the graphic may be color-coded and/or shape-coded, icon-coded, or alphanumeric-coded to match the information with its proper month. (Except in single-color versions of the overlay calendar, when shape-coded, icon, or alphanumeric symbols/indicia are best used). A legend would be placed on the overlay calendar to match the coded indicia/symbols with their associated month.

4. Indicia/symbols are used to clearly indicate which page, or graphic of the overlay calendar is next for the up-coming month. Pages, and/or graphics are numbered or otherwise identified for this function. In the case where no page/graphic change is necessary, icons, shape-coding, or alpha-numeric coding could be used to indicate the next upcoming month on the same graphic/page

5. The name of each month would be located on its associated graphic or on a nearby page of the calendar. In some versions the name could be on a picture page attached to the month's graphic.

6. Numbers and/or symbols can be placed next to the name of each month to let the user know how many days are in that month. This information could also be placed on other areas instead of next to the associated months name.

7. In multi-year versions of the overlay calendar, the year of the month is placed next to the name of each month.

### Various Embodiments Of The Present Invention

Described below are various different embodiments using the overlay calendar of the present invention. These are provided for illustrative purposes and the present invention should not be limited to any one example. It should be understood by those of ordinary skill in the art that there is no requirement that every compatible month share the same graphic. The following are examples from the Gregorian calendar, but the same idea of grouping compatible months onto a single graphic is used in the Julian, Jewish, and Islamic calendars.

It should further be recognized that the drawings represent the days of the month in just one particular format. The overlay calendar of the present invention is not limited to square-type graphics representing the months and their days. Other formats are just as viable in representing the months and their days, as long as the general rules described in this document are used to make the overlay calendar.

Each grouping of months shares the same graphic. The grouping of compatible months basically stays the same for each year-type ( there is no requirement that every compatible month share the same graphic). For example, the grouping of months for a one-year non-leap year calendar is basically the same for every one-year non-leap year type. The same rule applies to a single leap-year calendar, and the three types of multi-year calendars as well. The order of the groupings within each calendar-year type is not limited to the order shown in the examples below, the order in the examples below represent just one particular format.

### A One-Year Overlay Calendar of a Non-Leap Year ( the Year 2003 in this Case)

January-October.: Both months begin on a Wednesday and end on a Friday.

February-March-November.: All three begin on a Saturday, each one ends on a differently named day

April-July: Both months begin on a Tuesday and end on a differently named day) (FIG. 3)

May: This month begins on a Thursday, there are no other months compatible with May in 2003.

June: June begins on a Sunday and is not compatible with any other 2003 months.

August.: No other 2003 months are compatible with August.

September-December: Both months begin on a Monday, each one ends on a differently named day. This is the same type of situation as April-July in FIG. 3.

The months May, June, and August were not compatible with any other months in the year and therefore did not share their individual graphics with any other months in 2003. Note that only seven graphics were used to make a one-year calendar. The one-year calendar represented the year with fewer parts than a regular one-year calendar.

### A One-Year Overlay Calendar of a Leap Year ( the Year 2004 in this Case)

The groups of months are now different than the previous one-year Overlay Calendar. This is due to the extra day found in February during a leap-year.

January-July-April: January and July end on a same-named day but April's end day is a different-name day. (Similar to FIG. 3, except with three months sharing the same graphic.)

February-August.: Both months end on differently-named days. (Similar to FIG. 3.)

March-November.: Both months end on differently named days. (Similar to FIG. 3.)

May: May is not compatible with any of the other 2004 months. No other months in 2004 begin on the same-named day as May (Saturday in this case).

June: June is also not compatible with any other months in 2004.

September-December.: September and December both begin on Wednesday but end on differently named days. (Similar to FIG. 3.)

October: October is not compatible with any other months in 2004, therefore, like May and June, it gets its own graphic.

There are only seven graphics in a one-year leap-year Overlay Calendar. It is able to show the year 2004 with fewer graphics than a regular one-year calendar.

### A Two-Year Multi-Year Overlay Calendar, a Non-Leap Year Followed by a Leap-Year.(2003 and 2004)

The multi-year Overlay Calendar is not limited to representing just two years. In such a case, of course, the grouping of months would be different, but follow the same rules for making an Overlay Calendar as previously described.

January 03-October 03: Both months begin on a day with the same name, and end on a day named the same.

February 03-March 03: Both begin on a same-named day but end on differently named days.

April 03-July 03-June 04: They all begin on a same-named day but only 2 months end on a same-named day.

May 03-July 04: Both months begin on a same-named day and end on same-named days. Note that July is from the second year.

August 03-October 04: Both months begin on a same-named day and end on a same-named day. Note that October 04 is from the second year.

September 03-December 03: Both begin on a same-named day, but end on differently-named days.

January 04-April 04: Both begin on a same-named day, but end on differently-named days.

February 04-August 04: See above.

March 04-November 04: See above.

May 04-November 03: See above. Note that November 03is from the previous year.

September 04-December 04.: Both begin on a same-named day, but end on differently-named days.

Note that only eleven graphics are used to make this two-year calendar. A two-year calendar of the present invention would probable have great consumer appeal, you buy a two year calendar for less than the price of a one-year old-type calendar. Also, the calendar here lasts twice as long, with fewer graphics than a similar sized old-type one-year calendar.

### A Two-Year Overlay Calendar, a Leap-Year Followed by a Non-Leap Year. (2004 and 2005)

January 04-April 04.: Two months begin on the same-named day. One month ends on a differently-named day from the other two.

February 04-August 04-May 05: Note that May 05 is from the next year.

March 04-November 04-August 05: Another month from the next year.

June 04-November 05: Note November 05 is from the next year.

September 04-December 04-June 05: Note June 05 is from the next year.

January 05-October 05-May 04: Note that May 04 is from the previous year.

February 05-March 05: Note that these two and June 04-November 05 are compatible, but it was decided to place two of the four compatible months on their own graphic. There is no requirement that all compatible months share the same graphic.

April 05-July 05.

September 05-December 05 .

This two-year calendar uses only nine graphics. It could be sold for less than an old-style one-year calendar, and like the previous example, lasts twice as long as regular 12-graphic calendar.

### A Two-Year Overlay Calendar, Two Non-Leap Years (The Years 2005 and 2006 in this Example).

January 05-October 05: Similar to FIG. 2.

February 05-March 05.

April 05-July 05.

June 05-November06 .

August 05-May 06.

September 05-December 05-June 06: See FIG. 4.

January 06-October 06-May 05: All three begin on a same-name day and end on a same-name day.

February 06-March 06: Similar to FIG. 3.

April 06-July 06.

September 06-December 06.

August 06-November 05.

Total of eleven graphics. This two-year calendar is cheaper to make and sell than an old-type one-year calendar, and, like the two previous calendars, also lasts longer than a similar-sized regular calendar.

### Various Other Embodiment Contemplated by The Present Invention

Another embodiment of an Overlay Calendar is simply placing two or more one-year Overlay Calendars together as a single package. In this manner, it is possible to stack them one on top of the other, or bind them together. The graphics of an Overlay Calendar can be bound together on one of the four edges of the paper or medium that contains the graphic (and then placed in a vertical or horizontal position). A vertical position could be used to make a wall poster calendar. They can also be stacked one on top of the other. They can also be placed in a tray or container designed to hold the graphics in a vertical position. They can also be placed in a tray or container designed to hold the graphics in a horizontal position. Folded, triangular-shaped holders, also can support the bound or unbound graphic pages of an Overlay Calendar. The Overlay Calendar could also be displayed/imprinted on a single page, poster, or hanging fabric. Pictures or drawings could be printed or otherwise placed on the backside of any page displaying the graphic(s). This is the configuration of a normal calendar. These pages could then be bound together at any edge to form the structure of an Overlay Calendar.

The graphics can be placed together in any order, but there is an best-use order for the graphics. This best-use order allows the least amount of shuffling back and forth between the different graphics for each up-coming month. This best-use order depends on several factors; How many months share each graphic, whether the calendar is for one year or multiple years, and, whether the calendar represents leap years or non-leap years. In the case of a multi-year calendar, the combinations of leap-years and non-leap years is also a factor. ( see examples 1 through 5 above).

In the Overlay Calendar there is no requirement that every month share its graphic. In fact, in the case of a one-year Overlay Calendar there is a least one month that cannot share its graphic (It does not share a same-name beginning day with any of the other months in the calendar). Each month that shared a graphic would of course have its name displayed in close proximity to its shared graphic. In the case of a multi-year Overlay Calendar, where months from different years could share the same graphic, indicia/symbols near the month's name would show the year associated with that month (12) (FIG. 4). Of course, months that do not share their graphic also would have their name displayed on or near their graphic.

One option, immediately adjacent to each month's name would be a number that tells the viewer how many days are in that month (not shown on example drawings).

In a regular calendar you just flip through the pages consecutively as each month becomes current. In an Overlay Calendar the up-coming month is not always found on the next adjacent page. It may be many pages away from the current page. For this reason, indicia/symbols and numbers are placed on each graphic that direct the user to the page of the next up-coming month. (13). (A straight arrow pointing is one example in FIG. 4).

Within each graphic, indicia/symbols are used to represent days of the month(s) that appear on the graphic. Text and indicia can be placed with a given day's indicia/symbols to give information to the user (14) (FIG. 4.) Text and indicia/symbols within a given day indicia/symbol could also direct the user to some other area of the calendar to obtain information. Examples of information that could be placed in or near the day- indicia/symbols are: birthdays, special events, medical appointments, referrals to web sites or other off-calendar events or sites, or referrals to other parts of the calendar itself.

Separate or combined areas on or near the appropriate graphic/page or a different graphic/page could contain information associated with a specific month or day. Color should be used as part of the Overlay Calendar's function and use. Since most graphics will display at least two different months simultaneously, some confusion might develop as to which information or indicia/symbol is associated with which month. Each month within a shared graphic would be assigned its own specific color. All indicia/symbols or information associated with that month would be the color associated with that month. There is one exception to this rule. Elements or indicia/symbols that are common to all the months sharing a graphic or not related to any of the months within a shared graphic would be a color not exclusively associated with any of the months within a shared graphic. An example would be the indicia/symbols that represent the days of the month(s) within the shared graphic, and graphic/page numbers.

There is another way to reduce confusion between the different months sharing a single graphic. Use indicia/symbols that are exclusively associated with an individual month within a shared graphic. Place these indicia/symbols next to information that is associated with a specific month. These indicia/symbols could be a neutral color, or a color specifically associated with a given month as described in the previous paragraph. The information itself could be color-coded to match up with an associated month. Single-color or patterned indicia/symbols would be best used in one-color productions of the Overlay Calendar, but could also be used in a multi-colored calendar.

One way to increase the usefulness of an Overlay Calendar is to place ads of potential interest or help directly onto each day-indicia/symbol. The user would then see the advertisement as he or she viewed the calendar each day. By selling ads, the calendar maker could afford to sell the calendar to the consumer for a lower price, increasing market advantage. Graphics/pages that are no longer needed could be perforated near an edge or the binding to tear them from the calendar.

Tabs could extend from the edges of each of the pages that hold the graphics. These tabs would let the calendar user select the next upcoming page or to locate other information on a given page. Placing the tabs at different points on each page's edge allows all the tabs to be read at a glance.

One of the embodiments of the Overlay Calendar is a calendar that hangs on a vertical surface or hangs vertically in space. This calendar would display an “art rendering” ( a picture, drawing, or other design types) above the graphic. The graphic and art rendering could be bound together or otherwise placed in proximity to each other as is done in regular calendars that also display a picture, drawing or art display. A small desk calendar with art renderings and the graphics would also be contemplated.

The graphics of the Overlay Calendar could be imprinted, engraved, carved, etched, or otherwise placed on paper sheets or some other backing material. The graphics could also be placed on a single piece of paper sheet or backing material. The sheets could then be stacked and placed in a holder in a vertical or horizontal position. Or the sheets could be bound together at one edge and placed in a vertical or horizontal position. As in regular calendars, pictures could be bound to the graphics for simultaneous display with the graphic. Or, placed on the same sheet as the graphic for simultaneous display as is done in some smaller calendar versions. The calendar of the present invention may also be combination overlay-memo calendar. In this embodiment, the calendar has room for the user to write permanent or erasable memos on each of the areas that represent a day of the month, as seen in FIG. 4 (Christmas).

Other aspects and features of the present invention can be obtained from a study of the drawings, the disclosure, and the appended claims.

We claim:

1. An overlay calendar comprising at least one single graphical representation for at least two months, where the single graphical representation includes a name of each of the at least two months, indicia representing each day of a week associated with any month of a year, date indicia associated with each of the dates for each of the at least two months and an end day indicia signifying end days for the each of the at least two months, each of the at least two months on the single graphical representation begin on a same day.

2. The overlay calendar of claim 1, wherein the at least two months is three or more months, where the single graphical representation includes a name of each of the at three or more months, the numerical representations represent each of the dates for each of the three or more months and the end day indicia signifies end days for the each of the three or more months, each of the three or more months on the single graphical representation begin on the same day.

3. The overlay calendar of claim 1, wherein the single graphical representation includes additional space for a user to write permanent or erasable memos on each of the areas that represent a day of the month.

4. The overlay calendar of claim 1, wherein the at least two months are in a same year.

5. The overlay calendar of claim 1, wherein the at least two months are in a different year.

6. The overlay calendar of claim 1, further comprising more than one graphical representation of different months each having a same beginning day.

7. The overlay calendar of claim 6, wherein the different months on the more than one graphical representation are associated with more than one year.

8. The overlay calendar of claim 7, wherein the order of the different months is not in sequential order from one graphical representation to another graphical representation.

9. The overlay calendar of claim 8, further comprising indicia associated with each month's names for pointing to a next graphical representation that shows a displayed next upcoming month for a same year or a different year.

10. The overlay calendar of claim 1, wherein information placed on the at least one graphical representation may be color-coded, shape-coded, icon-coded, or alphanumeric-coded to match information with the at least two months

11. The overlay calendar of claim 10, further comprising a legend to match the coded information.

12. The overlay calendar of claim 1, further comprising indicia used to indicate an up-coming month.

13. The overlay calendar of claim 12, wherein the single graphical representation is formed on a single page, and the indicia is used to show a page or pages for the up-coming month.

14. The overlay calendar of claim 1, further comprising numbers or symbols placed next to a name of each of the at least two months to show how many days are in each month.

15. The overlay calendar of claim 1, wherein the at least two months are in a different year and a year indicia is placed near the month of the at least two months.

16. The overlay calendar of claim 1, further comprising a single graphical representation for a single month which does not have a same beginning day as another month of the year.

17. The overlay calendar of claim 1, wherein the at least one single graphical representation includes at least two single graphical representations, wherein a first of the single graphical representation includes at least two months having the same beginning day and a second of the single graphical representations includes one of a single month and at least two months having the same beginning day, the at least two single graphical representations being on a same page.

18. The overlay calendar of claim 17, wherein the at least two single graphical representations are on separate pages.

19. The overlay calendar of claim 18, further comprising tabs extending from the separate pages.

20. The overlay calendar of claim 17, wherein the at least two single graphical representations being on a different side of the same page.

21. An overlay calendar comprising at least one single graphical representation for at least two months, where the single graphical representation includes at least two months, indicia representing each day of a week associated with any month of a year, date indicia associated with each of the dates for each of the at least two months and an end day indicia signifying end days for the each of the at least two months, each of the at least two months on the single graphical representation begin on a same day.

22. The overlay calendar of claim 21, wherein names of the at least two months are located on one of the single graphical representation and on a nearby location signifying the at least two months on the single graphical representation.

23. An overlay calendar comprising at least one single graphical representation for at least two months, where the single graphical representation includes at least two months, indicia representing each day of a week associated with any month of a year including the at least two months, and date indicia associated with each of the dates for each of the at least two months, each of the at least two months on the single graphical representation begin on a same day.
